(19) United States
(12) Patent Application Publication
(10) Pub. No.: US 2026/0231878 A1
(43) Pub. Date: Aug. 13, 2026

(54) HYDROPONIC GROW BLOCK CULTIVATION PRODUCT

(71) Applicants: Sudheer Chikkere Shivaswamy, Bengaluru (IN); Pallavi Chikkere Shivaswamy, Bengaluru (IN)

(72) Inventors: Sudheer Chikkere Shivaswamy, Bengaluru (IN); Pallavi Chikkere Shivaswamy, Bengaluru (IN)

(21) Appl. No.: 19/161,225

(22) PCT Filed: Feb. 26, 2024
(86) PCT No.: PCT/IN2024/050205

§ 371 Date: Aug. 30, 2025

(30) Foreign Application Priority Data
Mar. 1, 2023 (IN) 202341013796

(51) Int. Cl. A01G 24/46; A01G 24/50

(52) U.S. Cl. CPC A01G 24/46; A01G 24/50

(57) ABSTRACT

A hydroponic cultivation product that is designed to be compatible with various grow systems in various shapes and form is disclosed. Said product comprises of a compacted grow media comprising of two layers, wherein materials of hygroscopic properties form the bottom layer, and a thick layer of grow media forms the top layer. The compacted grow media block is encompassed in a casing made of fabric or plastic. A hole is drilled at the center of the compacted block, and a corresponding opening is provided at the top part of the casing to help align the irrigation system and watering equipment used in cultivation, when installed.

### FIELD OF THE INVENTION

The present invention, in general, relates to grow bags. Particularly, the present invention relates to a hydroponic grow block cultivation product with custom designed substrate structure and integrated hydroscopic material layer to aid moisture absorption and retention in the grow media block, wherein said block is encased in a fabric or plastic grow bag with perforation/holes in the bottom, is the inlet for water or liquid nutrients feeding.

### BACKGROUND

Different types of grow bags are known in the state of the art literature. For example, the UK patent application GB2447441A teaches a grow bag containing a grow medium and one or more walls of woven plastics material; characterized in that said walls are formed of flat woven strips of plastics. Indian Patent No. 382036 details an open air grow bag suitable for bio-cultivation in open air conditions, therein offering an alternative for polyhouse farming.

The present invention teaches a hydroponic cultivation product that is designed to be compatible with various grow systems in various shapes and form. The product helps streamline growing process making the workflow efficient and optimizes space and resource usage. Existing systems are not multi-platform compatible, and are often driven by rigid usage technique in the form of equipment or grow needs.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments nor delineate the scope of any or all embodiments.

The present invention provides a flexible solution for most conventional hydroponic grow systems and techniques. The invention helps streamline and improve the growing process. The invention has proven to save money and time once adopted and processes are streamlined. The design is compatible with both top-feeding and bottom-feeding irrigation techniques traditionally used in hydroponics.

According to the embodiment of the invention, the perforation/holes at the bottom of the hydroponic cultivation product are an inlet to feed water or nutrient solution to the plants.

According to the embodiment of the invention, the compressed grow media block is lined with fibrous mesh structures that help absorption of moisture through the block, therein helping maintain uniform moisture in the block. This is of great advantage when employing bottom-feeding irrigation technique.

According to the embodiment of the invention, the grow media block is lined with a fibrous/spongy hygroscopic material that helps suction of water and nutrients through the perforation/holes at the bottom. This promotes uniform distribution and absorption of the liquid solution and helps maintain moisture level in the block.

According to the embodiment of the invention, the design of the perforation/holes at the bottom of the product ensures proper drainage and stable dry backs required to ensure proper moisture in the root zone. Further, according to the embodiment of the invention, when plants grown in the product and stacked on bigger size products, the design of the perforation / holes and the hygroscopic layer at the bottom of the product aids plant roots to grow through the layers and holes without stressing the plant.

According to the embodiment of the invention, the flexibility with multiple sizes helps to grow crops from seeds or saplings through their progressive vegetative and flowering stages of growth.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The foregoing and other objects, aspects, features, and advantages of the present solution will become more apparent and better understood by referring to the following description taken in conjunction with the accompanying drawings, in which:

FIG. 1 is a drawing illustrating the different components of the grow block.

FIG. 2 is a drawing depicting the fabric/plastic bag.

FIG. 3 is a drawing showing the compaction process.

FIG. 4 is a drawing illustrating the compacted media.

FIG. 5 is a drawing depicting the block after a hole is drilled on the top.

FIG. 6 is a drawing showing the expanded view of the block in the form of cube.

FIG. 7 is a drawing illustrating the showing the assembled view of the block.

FIG. 8 is a drawing showing the expanded view of the block with the top open to form a pot shape.

FIG. 9 is a drawing showing the expanded view of the block with a cube shaped product stacked on the pot shaped product.

### DETAILED DESCRIPTION

The preferred embodiments of the present invention will now be explained with reference to the accompanying drawings. It should be understood however that the disclosed embodiments are merely exemplary of the invention, which may be embodied in various forms. The following description and drawings are not to be construed as limiting the invention and numerous specific details are described to provide a thorough understanding of the present invention, as the basis for the claims and as a basis for teaching one skilled in the art how to make and/or use the invention.

The preferred embodiment of the invention discloses a hydroponic cultivation product that is designed to be compatible with various grow systems in various shapes and form. The product can be designed such to help streamline the growing process, making the workflow efficient while optimizing space and resource usage.

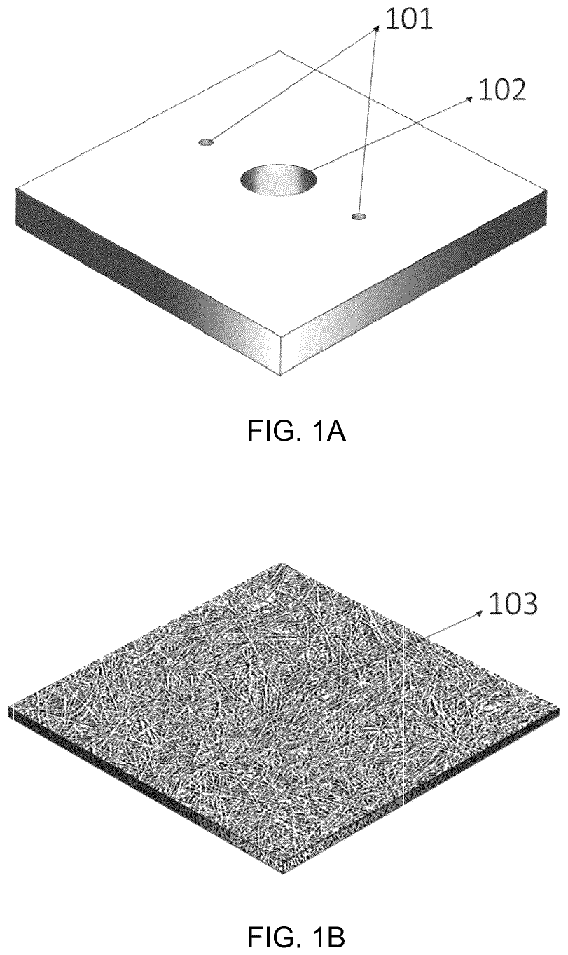

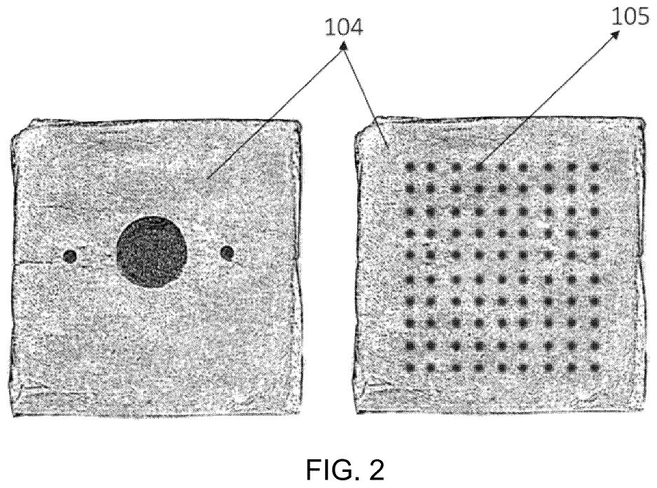

FIG. 1 illustrates the different components of the grow block. FIG. 1(a) shows the compressed media block 101 featuring a hole 102 at the top. The grow media is an essential part required for cultivation and growth of the crops. The choice and mix of the grow media will vary based on the intended use and application of the block. FIG. 1(b) depicts the fibrous/spongy medium 103 that is chosen to be integrated with the grow media block. As shown in FIG. 2, the components are encased in a fabric/plastic material configured to hold the block together through the various cultivation stages. The bottom portion of said fabric / plastic material is characterized by a plurality of perforation or holes.

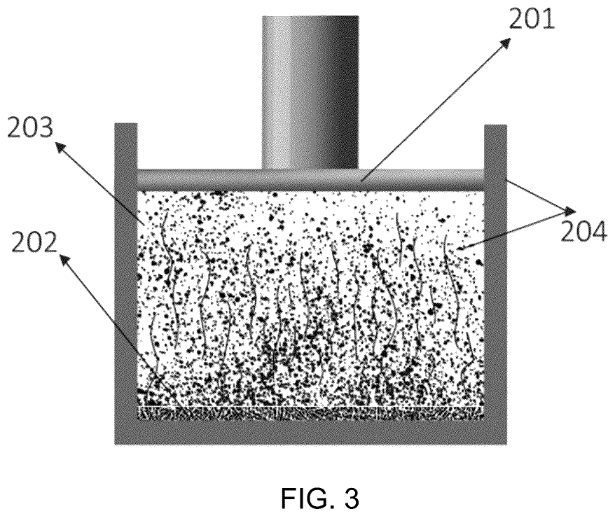

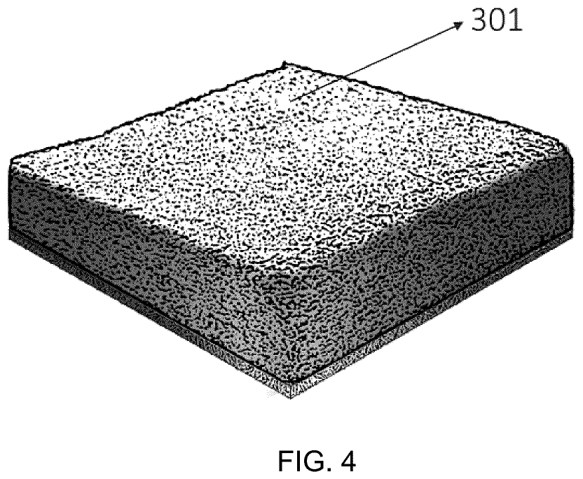

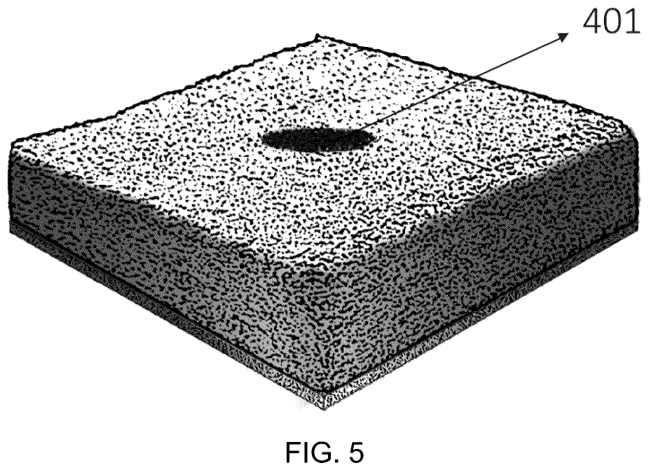

FIG. 3 illustrates the compaction process as per the preferred embodiment of the present invention. The various components forming the grow block are filled into a compactor, wherein a spongy/fibrous medium/material made of material with hygroscopic properties forms the bottom layer 202. On top of said layer is filled in a thick layer 203 of grow media, wherein a part of said grow media comprises of a mesh-like substrate 204 that crisscrosses through said layer. Said mesh-like substrate comprises of woven fibers from the grow media that is being used. Once the compactor is suitably loaded, it is compacted by the action of the piston 201, to obtain a compacted grow media 301, as shown in FIG. 4. Referring to FIG. 5 the compressed grow media is then taken out of the compactor, whereupon it is placed on a drilling machine to drill a hole 401 through the center. The size of the hole will depend on the size of the block.

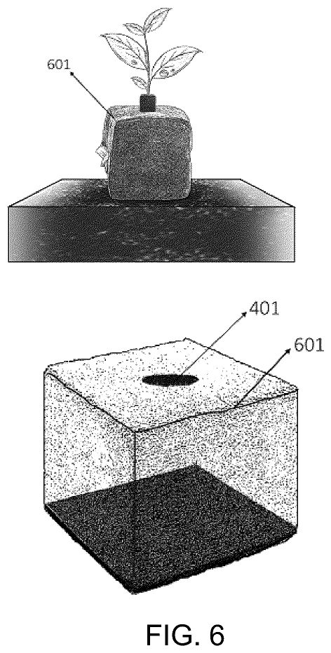

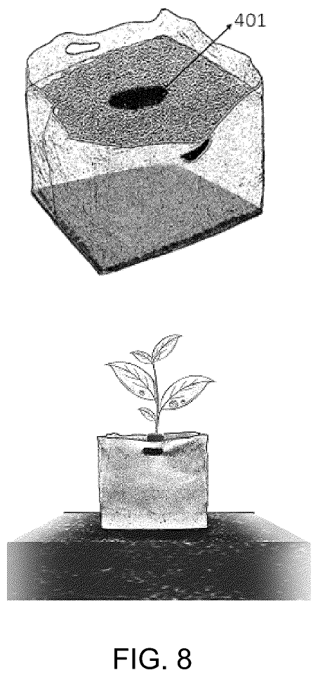

The compacted grow media is then encompassed in a casing made of fabric or plastic, as shown in FIG. 2, wherein said casing consists of a top portion and bottom piece that are stitched together on the sides to form a cube shape or the top portion is left open to form a pot shape. Said bottom piece is characterized by a plurality of perforation or holes 105 wherein the size and pattern of the holes vary based on the grow media used, size and other variables that will impact the usage. A hole is cut on the top piece of the casing fabric, wherein said hole is positioned to align with the hole drilled on the grow media block once assembled. In one embodiment, as shown in FIG. 6, the grow media is encompassed in a covered bag to make it cube shaped. In FIG. 8, the grow media is encompassed in a bag with the top open, to make it pot shaped.

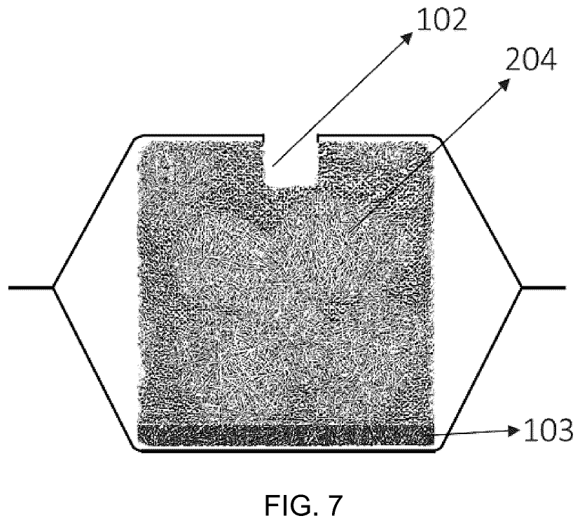

FIG. 7 shows the assembly of components. The compressed grow media block is inserted between the top and bottom fabric or plastic layers, wherein the ends of the fabric / plastic are sealed to ensure that said grow media remains within the block. As shown in the figure, the center of the top fabric 102 and the hole in the grow media block are aligned to ensure access into the grow media. The center hole helps to align irrigation system and watering equipment used in cultivation. The equipment may be mounted on the block by cutting through the fabric. The extra fabric/plastic width is folded for compact packing.

In the cultivation center, based on the intended type of crop, the blocks are hydrated as per specification. The blocks can be assembled on trays or tables for easy expansion. The design of the grow media substrate helps with suction of fluids into the cultivation blocks. The spongy/fibrous medium used at the bottom of the grow media block helps with suction of water/feed into the grow block. On hydration, the grow block expands therein filling up the space inside the casing. Once expanded the block can be used to seed/transplant plants.

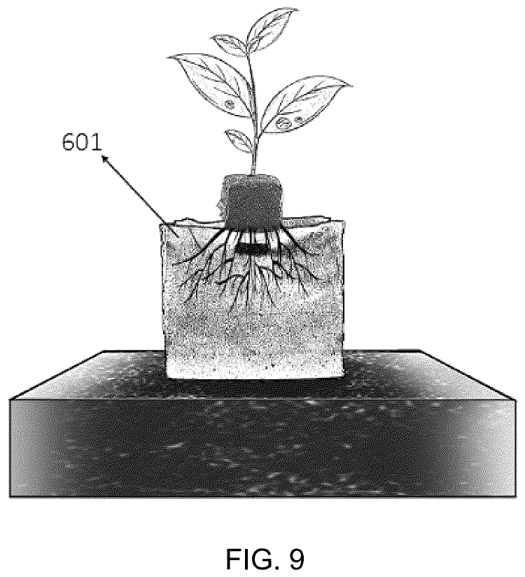

Referring to FIG. 8, in another embodiment, the grow media is put in an open bag to make pot. As shown in FIG. 9, the intended design of the grow block helps to optimize on space by using smaller size blocks during the early stage of plant development and gradually transplant to bigger size blocks. Doing so helps to optimize the number of crops grown at a given point of time and defines a workflow for the plants to grow through various stages. The use of multiple size blocks through various stages of plant cultivation are illustrated in the figure.

Although the present invention has been described in connection with the preferred embodiments thereof with reference to the accompanying drawings, it is to be noted that various changes and modifications are possible and are apparent to those skilled in the art. Such changes and modifications are to be understood as included within the scope of the present invention unless they depart therefrom.

The claimed invention is:

1. A hydroponic cultivation product compatible with various grow systems, characterized by:
bottom layer comprising of a spongy or fibrous medium having hygroscopic properties; and
thick layer of grow media positioned over the bottom layer, wherein a part of said grow media comprises of a mesh-like substrate that crisscrosses through said layer, wherein said layers are compacted vertically to obtain a compacted grow media.

2. The hydroponic cultivation product as claimed in claim 1, wherein a hole is drilled at the top center part of the compacted grow media.

3. The hydroponic cultivation product as claimed in claim 1, wherein the grow media is encompassed in a casing made of fabric or plastic.

4. The hydroponic cultivation product as claimed in claim 2, wherein a plurality of perforation or holes are provided on the bottom piece to create suction/siphon effect of fluids into the block, wherein the size and pattern of the holes vary based on the grow media used, size and other variables that will impact the usage.

5. The hydroponic cultivation product as claimed in claim 1, wherein the mesh-like substrate comprises of woven fibers, wherein said mesh-like substrate helps to improve absorption capability and maintain moisture inside the block.

6. The hydroponic cultivation product as claimed in claim 1, wherein the grow block is adapted to expand on hydration, therein filling up the space inside the garden fabric casing.

7. A method to make the compacted grow media, said method comprising the steps of:
filling the various components forming the grow block into a compactor, wherein the spongy or fibrous medium made of material with hygroscopic properties forms the bottom layer, wherein a thick layer of grow media is arranged on top of said bottom layer;
compressing said layers from the top by the action of a piston to create a compacted grow media; and
encompassing said grow media block in a casing made of garden fabric.

8. The method as claimed in claim 7, wherein a hole is cut on the top piece of the casing fabric, wherein said hole is positioned to align with the hole drilled on the grow media block once assembled.

9. The method as claimed in claim 7, wherein the center hole helps to align irrigation system and watering equipment used in cultivation.
